(19) United States
(12) Patent Application Publication
(10) Pub. No.: US 2012/0307257 A1
(43) Pub. Date: Dec. 6, 2012

(54) SWEPT LIGHT SOURCE APPARATUS AND IMAGING SYSTEM INCLUDING THE SAME

(75) Inventors: Minoru Yoshii, Tokyo (JP); Eiichi Fujii, Kamakura-shi (JP)

(73) Assignee: CANON KABUSHIKI KAISHA, Tokyo (JP)

(21) Appl. No.: 13/577,883

(22) PCT Filed: Jan. 27, 2011
(86) PCT No.: PCT/JP2011/052201

§ 371 Date: Aug. 8, 2012

(30) Foreign Application Priority Data
Feb. 12, 2010 (JP) 2010-029279

(51) Int. Cl. G02F 1/11; G02B 26/00; G02B 26/02; G01B 9/02; H01S 3/13

(52) U.S. Cl. 356/479; 359/349; 359/232; 359/290; 359/285

(57) ABSTRACT

The present invention provides a light source apparatus capable of producing stable oscillation and performing high-speed wavelength sweeping over a desired wavelength range.

A swept light source apparatus in which oscillation wavelength is continuously changeable is provided. The apparatus includes, inside a resonator, an optical amplification medium that amplifies light, a first device configured to disperse light emitted from the optical amplification medium and thus produce beams having different wavelengths, a second device functioning as a non-focusing optical element and configured to collimate the beams having different wavelengths resulting from the dispersion by the first device, and a selecting device configured to select a beam having a specific wavelength from among the beams collimated by the second device. The beam having the specific wavelength selected by the selecting device is fed back to the optical amplification medium.

### TECHNICAL FIELD

The present invention relates to a swept light source apparatus in which the oscillation wavelength is continuously changeable and to an imaging system including the same.

### BACKGROUND ART

In the fields of communications network and examination systems, various light sources, in particular, laser light sources whose oscillation wavelengths are changeable, have been used.

In the field of communications network, the wavelength is desired to be switchable at a high speed. In the field of examination systems, wavelength sweeping is desired to be performed at a high speed over a wide range.

Exemplary applications of such a wavelength-tunable (swept) light source in the field of examination systems include a laser spectroscopy system, a dispersion-measuring system, a film-thickness-measuring system, a swept-source optical-coherence-tomography system, and the like.

Optical coherence tomography (hereinafter abbreviated to OCT) is a technique of obtaining cross-sectional images of a sample by utilizing low-coherence interference. Researches on this imaging technique have been energetically conducted in recent years in the medical field because, for example, the technique provides a micron-order spatial resolution and is characterized by non-invasiveness.

At present, OCT provides cross-sectional images of several millimeters in depth with resolutions of several micrometers in the depth direction, and is applied to ophthalmologic imaging, dental imaging, and the like.

The swept-source (SS)-OCT system temporally sweeps the oscillation wavelength (frequency) of the light source and is categorized into the Fourier-domain (FD)-OCT system. A spectral-domain (SD)-OCT system, which is another FD-OCT system, requires a spectroscope that separates interfering light into different spectral components, whereas the SS-OCT does not. Therefore, the SS-OCT has small loss of light and is expected to provide images at a high signal-to-noise (S/N) ratio.

A medical imaging system including the swept light source is suitable for use in an examination (in-situ/in-vivo imaging) in which tissues of a living body is directly examined without taking any sample tissues therefrom, because the imaging time can be reduced by increasing the sweeping speed.

PTL 1 discloses a wavelength-tunable light source including an optical amplifier and a reflector provided outside the optical amplifier. The reflector includes a diffraction grating. FIG. 15 shows the light source disclosed by PTL 1.

Referring to FIG. 15, a portion of light emitted from an optical amplifier 1501 is reflected by a beam splitter 1534 and strikes a diffraction grating 1506. Then, a beam having a Bragg wavelength is reflected back to the optical amplifier 1501, where the beam is amplified and is output to a fiber 1544. The light source also includes a total reflection mirror 1540 and an isolator 1542. The diffraction grating 1506 is rotatable. Thus, the wavelength of the reflected beam is changeable.

PTL 2 discloses a laser apparatus that emits a laser beam in which light emitted from a laser medium is dispersed to form beams having different wavelengths by a diffraction grating, and one of the dispersed beams is selected and is fed back to the laser medium by a spatial modulator.

FIG. 16 shows the laser apparatus disclosed by PTL 2. Light emitted from an end face 1604 of a laser medium 1601 is transmitted through a lens 1605 and is diffracted by a diffraction grating 1606. The diffracted beams having different wavelengths travel in different directions, and are focused on different pixels (including 1608a and 1608b) of a spatial modulator 1608 by a focusing lens 1624. In the laser apparatus, the pixels of the spatial modulator 1608 are individually controlled to be in an ON state, where the incoming beam is reflected, and in an OFF state, where the incoming beam is absorbed. Thus, a beam reflected by one of the pixels (the pixel 1608b) follows the reverse optical path and is fed back to the laser medium 1601. In this case, an end face 1603 of the laser medium 1601 on the output side and the spatial modulator 1608 in combination function as a resonator. A laser beam 1613 having the wavelength of the feedback beam is output from the end face 1603.

The light source disclosed by PTL 1 selects a wavelength by changing the incidence angle of light on the basis of the mechanical driving of the diffraction grating 1506, and is therefore not suitable for high-speed wavelength sweeping.

The laser apparatus disclosed by PTL 2 selects, on the basis of the electrical driving of the spatial modulator 1608, a beam to be output from among the beams resulting from the dispersion by the diffraction grating 1606 fixed at a position inside the resonator formed by the end face 1603 of the laser medium 1601 and the spatial modulator 1608. The laser apparatus realizes a sweeping speed of 100 kHz or higher.

Nevertheless, the laser apparatus disclosed by PTL 2 needs to be configured such that the focusing lens 1624 is telecentric on the side thereof near the spatial modulator 1608. Therefore, unless the diffraction grating 1606, the focusing lens 1624, and the spatial modulator 1608 are positioned precisely, the feedback beam may not reach the laser medium 1601. Consequently, laser oscillation may not occur.

Probably, if the foregoing three elements are assembled with a certain level of precision, oscillation may occur over a very narrow wavelength range within the swept range.

However, to provide an apparatus realizing a stable light intensity and producing oscillation over the entirety of the swept range, difficult work including precise measurement and strict positioning needs to be done. That is, such an apparatus is difficult to provide.

### CITATION LIST

### Patent Literature

PTL 1 U.S. Pat. No. 5,862,162
PTL 2 Japanese Patent Laid-Open No. 2007-242747

### SUMMARY OF INVENTION

The present invention provides a light source apparatus capable of producing stable oscillation and performing high-speed wavelength sweeping over a desired wavelength range.

According to an embodiment of the present invention, there is provided a swept light source apparatus in which oscillation wavelength is continuously changeable. The apparatus includes the following inside a resonator: an optical amplification medium that amplifies light, a first device configured to disperse light emitted from the optical amplification medium and thus produce beams having different wavelengths, a second device functioning as a non-focusing optical element and configured to collimate the beams having different wavelengths resulting from the dispersion by the first device, and a selecting device configured to select a beam having a specific wavelength from among the beams collimated by the second device. The beam having the specific wavelength selected by the selecting device is fed back to the optical amplification medium.

The apparatus according to the embodiment of the present invention includes, inside the resonator, the first device configured to disperse light emitted from the optical amplification medium and thus produce beams having different wavelengths, the second device functioning as a non-focusing optical element and configured to collimate the beams having different wavelengths resulting from the dispersion by the first device, and the selecting device configured to select a beam having a specific wavelength from among the beams collimated by the second device.

The second device configured to collimate the dispersed beams having different wavelengths is a non-focusing optical element. Therefore, by determining the positions of the first and second devices, a swept light source apparatus capable of producing stable oscillation is provided even if the positional precision among the selecting device configured to select a beam having a specific wavelength and the first and second devices is not strictly satisfied.

Furthermore, the beam having the specific wavelength selected by the selecting device from among the beams collimated by the second device is fed back to the optical amplification medium. Thus, high-speed wavelength sweeping is realized.

### BRIEF DESCRIPTION OF DRAWINGS

FIG. 1 schematically shows a light source apparatus according to an embodiment of the present invention.

FIG. 2 explains the principles of the apparatus according to the embodiment of the present invention including diffraction gratings.

FIGS. 3A to 3C explain the principles and behavior of a spatial modulator applicable to the embodiment of the present invention.

FIG. 4 explains Bragg diffraction caused by a traveling-diffraction-grating device (acousto-optic device) applicable to the embodiment of the present invention.

FIGS. 5A and 5B explain Raman-Nath diffraction caused by the traveling-diffraction-grating device (acousto-optic device) and the behavior of the spatial modulator.

FIG. 6 schematically shows an exemplary light source apparatus including blazed diffraction gratings.

FIG. 7 schematically shows another exemplary light source apparatus including blazed diffraction gratings.

FIG. 8 schematically shows an exemplary light source apparatus including a traveling-diffraction-grating device (acousto-optic device).

FIGS. 9A and 9B schematically show a spatial modulator including a surface-acoustic-wave device.

FIGS. 10A and 10B schematically show an exemplary light source apparatus including traveling-diffraction-grating devices (acousto-optic devices).

FIG. 11 schematically shows another exemplary light source apparatus including traveling-diffraction-grating devices (acousto-optic devices).

FIG. 12 schematically shows a rotatable slit.

FIG. 13 schematically shows an exemplary light source apparatus including a ring fiber.

FIG. 14 schematically shows an exemplary optical-coherence-tomography system including the light source apparatus according to the embodiment of the present invention.

FIG. 15 schematically shows a known apparatus.

FIG. 16 schematically shows another known apparatus.

### DESCRIPTION OF EMBODIMENTS

The scope of the swept light source apparatus according to the present invention includes a wavelength-tunable light source in which a plurality of dispersing elements are provided inside a resonator including an optical amplification medium, the dispersing elements dispersing light to form beams having different wavelengths and collimating the dispersed beams, and in which a beam having a specific wavelength is selected by a spatial modulator that is driven at a high speed.

A general embodiment of the present invention will now be described with reference to the accompanying drawings.

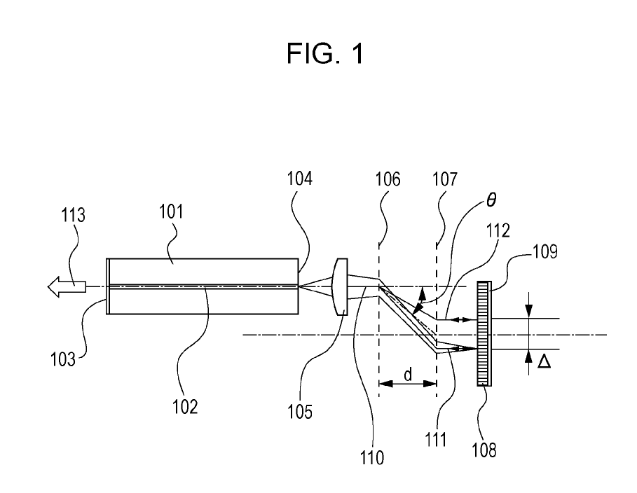

FIG. 1 schematically shows a swept light source apparatus according to a general embodiment of the present invention.

Referring to FIG. 1, an optical amplifier 101 has thereinside an active layer 102 corresponding to an optical amplification medium. A first diffraction grating 106, corresponding to a first device, disperses a beam of light radiated from the active layer 102 and thus produces beams having different wavelengths. A second diffraction grating 107, corresponding to a second device, is a non-focusing optical element that collimates the beams having different wavelengths resulting from the dispersion by the diffraction grating 106. A spatial modulator 108, corresponding to a selecting device, selects a beam having a specific wavelength from among the beams collimated by the diffraction grating 107.

When electrical energy is supplied from a power source (not shown) to the optical amplifier 101, optical radiation occurs in the active layer 102. The radiation is amplified and propagates toward end faces 103 and 104 of the optical amplifier 101, the end face 104 being anti-reflection-coated.

The radiation is transmitted through the anti-reflection-coated end face 104 and is emitted as a beam 110 to the outside. The beam 110 has astigmatism and the wavefronts thereof are asymmetric with respect to the optical axis. An optional optical system 105 converts the beam 110 into a beam in the form of spherical waves that are symmetric with respect to the optical axis.

The beam 110 in the form of spherical waves is dispersed by the diffraction grating 106 and thus forms beams having different wavelengths. The dispersed beams are collimated by the diffraction grating 107. The collimated beams are focused on the spatial modulator 108.

The spatial modulator 108 includes a plurality of pixels. The mode of the pixels are selectively switchable between a reflective mode (state) and a non-reflective mode (state).

In the light source apparatus shown in FIG. 1, the beam 110 of light radiated from the active layer 102 with a plurality of wavelengths is dispersed by the diffraction grating 106 and thus forms beams having different wavelengths, the dispersed beams are collimated by the diffraction grating 107, and the collimated beams perpendicularly strike the surfaces of the pixels of the spatial modulator 108.

When one of the pixels of the spatial modulator 108 is selectively switched to be in the reflective mode, the spatial modulator 108 and the end face 103 of the optical amplifier 101 in combination function as an optical resonator, and an output beam 113 having a specific wavelength is emitted from the end face 103. The beams of different wavelengths strike different pixels of the spatial modulator 108. Therefore, by changing the pixel switched to be in the reflective mode, the wavelength of the output beam 113 emitted from the end face 103 is changed. That is, the wavelength of laser oscillation is changeable. By sequentially selecting pixels, the wavelength of the output beam 113 sequentially changes. Thus, a swept light source apparatus is provided.

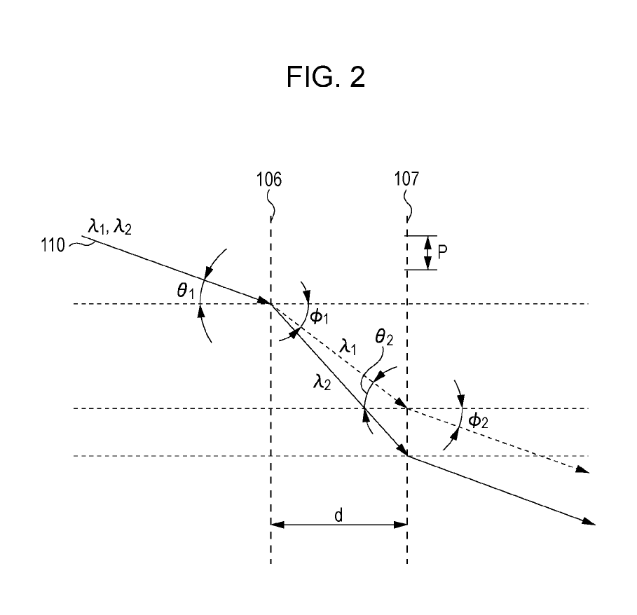

Referring now to FIG. 2, the principles of an effect, which is a major feature of the present invention, produced by the first device configured to disperse light and thus produce beams having different wavelengths and the second device configured to collimate the beams having different wavelengths resulting from the dispersion by the first device will be described.

FIG. 2 schematically shows the relationship between the beam 110 and the diffraction gratings 106 and 107 shown in FIG. 1.

The diffraction gratings 106 and 107, whose grating pitches P are equal, are spaced apart from each other by a distance d. The beam 110 including beams having wavelengths λ1 and λ2 enters the diffraction grating 106.

At the entry into the diffraction grating 106, the incidence angle θ₁ and the emergence angle (diffraction angle) φ₁ (the angles with respect to the optical axis, taking positive values in the clockwise direction) are expressed as follows:

$$\begin{matrix}[ Math . 1 ] & \\ m = \frac{P}{λ} ( sin {θ}_{1} - sin {φ}_{1} ) & ( 1 ) \\ where , m = \pm 1 , \pm 2 , … & \end{matrix}$$

Here, focusing only on the 1st-order diffracted beam and defining the directions of diffraction toward right and left in the direction of travel of the light as the negative and positive sides, respectively, m for the diffraction grating 106 is −1, and Equation (1) is translated as follows:

$$\begin{matrix}[ Math . 2 ] & \\ - 1 = \frac{P}{λ} ( sin {θ}_{1} - sin {φ}_{1} ) & ( 2 )\end{matrix}$$

where φ₁ is a function of λ. When the wavelength increases, φ₁ increases, that is, the diffraction angle increases. This implies that light is dispersed by the wavelength.

The same applies to the diffraction grating 107, which is expressed as follows:

$$\begin{matrix}[ Math . 3 ] & \\ m = \frac{P}{λ} ( sin {θ}_{2} - sin {φ}_{2} ) & ( 3 ) \\ where , m = \pm 1 , \pm 2 , … & \end{matrix}$$

In this case, the 1st-order diffracted beam travels toward left, meaning that m is +1 as below:

$$\begin{matrix}[ Math . 4 ] & \\ + 1 = \frac{P}{λ} ( sin {θ}_{2} - sin {φ}_{2} ) & ( 4 )\end{matrix}$$

When the diffraction gratings 106 and 107 are provided parallel to each other, the following holds:

[Math. 5]

φ₁θ₂, that is, sin φ₁=sin θ₂ (5)

When Equation (5) is substituted into Equations (2) and (4), the following holds:

[Math. 6]

sin θ₁=sin φ₂, that is, θ₁=φ₂, (6)

Hence, when the beam 110 perpendicularly enters the diffraction grating 106, the resulting dispersed beams emerge from the diffraction grating 107 at an angle perpendicular to the surface of the diffraction grating 107. That is, the following holds:

θ₁=φ₂=0 [Math. 7]

As is understood from the above, by employing two diffraction gratings, beams having different wavelengths can be collimated.

Letting the distance between the diffraction grating 106 and the diffraction grating 107 be denoted by d, the width (dispersion width) of the set of beams emerging from the diffraction grating 107 is expressed as follows:

$$\begin{matrix}[ Math . 8 ] & \\ Δ = d \cdot ( tan ( {sin}^{- 1} ( \frac{{λ}_{1}}{P} ) ) - tan ( {sin}^{- 1} ( \frac{{λ}_{2}}{P} ) ) ) & ( 7 )\end{matrix}$$

Here, supposing that the grating pitch P of the diffraction gratings 106 and 107 is 1.5 μm and the distance d between the diffraction gratings 106 and 107 is 10 mm, a wavelength-tunable light source apparatus operating with a center wavelength of 1.15 μm and a swept range of ±60 nm, i.e., a light source apparatus whose wavelength is changeable from 1.09 μm to 1.21 μm, will be considered.

The diffraction angle φ₁ is calculated to be 50.1±3.6° from Equation (1). The dispersion width Δ of the set of beams having different wavelengths is calculated to be 3.1 mm from Equation (7).

A beam is selected by one of the pixels of the spatial modulator 108 from among the beams dispersed over the range of 3.1 mm, and the selected beam is fed back to the optical amplifier 101 by a mirror 109. In this configuration, the end face 103, i.e., the output end, of the optical amplifier 101 and the mirror 109 in combination function as a resonator. Thus, laser oscillation in which the wavelength changes over the range of 1.09 μm to 1.21 μm is produced.

In the general embodiment of the present invention, the first device configured to disperse light and thus produce beams having different wavelengths and the second device functioning as a non-focusing optical element and configured to collimate the beams having different wavelengths resulting from the dispersion by the first device may be any of the following static elements: diffraction gratings (of transmissive or reflective types), prisms, grisms, and the like. A grism is a combination of a diffraction grating and a prism.

The first and second devices may alternatively be dynamic elements, such as acousto-optic (AO) devices that temporally and spatially produce traveling waves.

Theoretically, the first and second devices may be different kinds of optical elements. It is beneficial, however, if the first and second devices are of the same kind. If so, the positions of the first and second devices may not necessarily be adjusted very strictly. Here, the optical elements of the same kind are defined as follows. If the optical elements are diffraction gratings, the elements are configured at substantially the same grating pitch and with substantially the same thickness. If the optical elements are AO devices, the elements are configured to produce waves traveling at substantially the same speed and at substantially the same pitch.

The spatial modulator 108 (the selecting device configured to select a beam having a specific wavelength from among a plurality of beams), which will be described in detail below, allows a beam having a specific wavelength selected from among the beams having different wavelengths striking different wavelength-selecting portions of the spatial modulator 108 to be fed back to the optical amplifier 101.

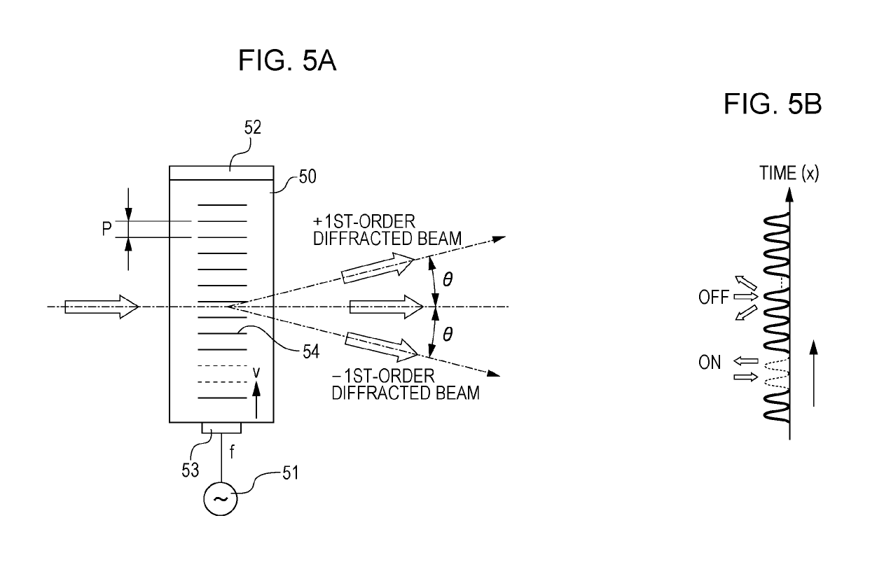

The above description concerns the principles of an effect produced by static dispersing elements. A dynamic dispersing element will now be described. FIGS. 5A and 5B explain the principles of an acousto-optic (AO) device.

The AO device shown in FIG. 5A includes an ultrasonic oscillator 53, an absorber 52, and a crystalline medium 50 held therebetween. Exemplary materials for the crystalline medium 50 include tellurium dioxide (TeO₂), crystal (SiO₂), glass (SF₆), and the like. The speed of the ultrasonic wave traveling through the crystalline medium 50 varies with the material of the medium 50.

The center driving frequency f_{c} produced by a driver 51 corresponds to the frequency of ultrasonic oscillation, and a wave 54 that travels through the medium 50 at a speed of v m/s is produced. This produces waves of compression and rarefaction of the refractive index. The wavelength P of the waves is expressed as follows:

$$\begin{matrix}[ Math . 9 ] & \\ P = \frac{v}{{f}_{c}} & ( 8 )\end{matrix}$$

FIG. 5B explains positional (temporal) changes in the waves of compression and rarefaction produced in the AO device shown in FIG. 5A.

The speed of travel of the ultrasonic wave through a crystalline medium composed of tellurium dioxide (TeO₂), for example, is 617 m/s in shear mode and 4200 m/s in longitudinal mode. In many cases, the AO device is driven at a frequency, i.e., the number of ultrasonic oscillations, from several tens of MHz to a hundred and several tens of MHz.

It should be noted that when a traveling diffraction grating in which waves temporally and spatially propagate through the medium is employed as the dispersing element, a Doppler shift produced by the traveling diffraction grating acts on the diffracted beams, and the number of oscillations of the diffracted beams is shifted by the number of oscillations of the ultrasonic wave.

Diffractions caused by AO devices include Bragg diffraction and Raman-Nath diffraction. In both cases of diffractions, the relationship between the incidence angle and the diffraction angle is expressed by Equation (1), and the wavelengths of the diffracted beams are shifted by an amount corresponding to the driving frequency f_{c} with respect to the wavelength of the incoming light. In general, Bragg diffraction provides higher diffraction efficiency than Raman-Nath diffraction.

The use of a plurality of temporally and spatially traveling, dynamic diffraction gratings produces the same effect as that produced by the two static diffraction gratings provided side by side as shown in FIG. 2. Therefore, dynamic diffraction gratings are applicable to the first and second devices according to the general embodiment of the present invention.

In the case where traveling diffraction gratings are employed, the two AO devices are to be provided such that the direction of travel of the wave and the direction of diffraction of each of the two devices are opposite to those of the other so that the Doppler effect, i.e., the above-mentioned addition or deduction of the ultrasonic frequency to or from the frequency of the diffracted beams, acting on each of the two devices is cancelled out by that acting on the other.

In such a configuration, however, the grating area of one of the AO devices on the downstream side needs to have a width corresponding to the dispersion width of the set of beams incident thereon. Nevertheless, if the dynamic characteristic of the AO diffraction gratings is utilized, the grating area of the downstream AO device does not necessarily have a width corresponding to the dispersion width.

An example of such a solution is to simultaneously modulate the driving frequencies of the two AO devices. This enables the realization of a system in which the wavelength is changeable only on the basis of the optical axes of the diffracted beams produced by the AO devices.

Such a system can be configured by utilizing Bragg diffraction, which provides high diffraction efficiency.

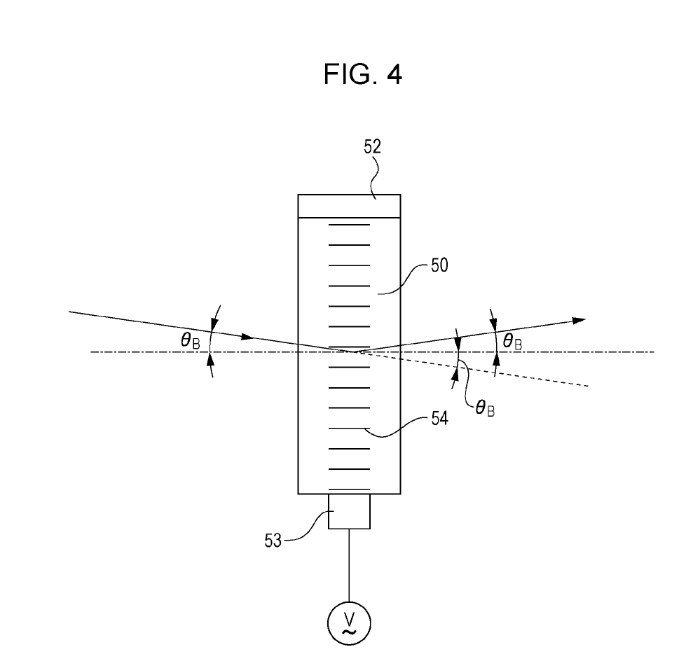

Referring now to FIG. 4, Bragg diffraction will be described. In FIG. 4, elements that are the same as or similar to those shown in FIGS. 5A and 5B are denoted by common reference numerals.

When a beam is incident on an AO device at an incidence angle θ with respect to a plane perpendicular to the direction of travel of the wave 54 and emerges at an emergence angle φ=−θ, the beam is specularly reflected with respect to the wavefront traveling through the AO device. In such a situation, the diffraction efficiency is the highest. The angle defined in this situation is called the Bragg diffraction angle θ_{B}.

The relationship between the wavelength λ of light and the center driving frequency f_{c} of the ultrasonic wave 54 established in Bragg diffraction is expressed as follows:

$$\begin{matrix}[ Math . 10 ] & \\ λ = \frac{2 \cdot v \cdot {θ}_{B}}{{f}_{c}} & ( 9 )\end{matrix}$$

where v denotes the speed of the ultrasonic wave 54 traveling through the crystalline medium 50 of the AO device. Here, when the Bragg diffraction angle θ_{B} is fixed, the wavelength λ and the driving frequency f_{c} are inversely proportional to each other.

For example, supposing that θ_{B} is fixed at 35 mrad) (2.0° and tellurium dioxide is employed in shear mode, the driving frequency f_{c} in a case where the range of the wavelength λ of the beam is set to 1.09 to 1.211 μm is calculated to be 39.6 to 35.7 MHz from Equation (9).

In this case, a reflective or transmissive microscopic aperture is provided only on the optical axis of the Bragg-diffracted beam so that only the beam of light that reaches the microscopic aperture is fed back to the optical amplification medium. Thus, a light source apparatus whose oscillation wavelength is changeable is provided.

That is, by combining two AO devices described above, the Doppler effects of the two devices cancel each other out. Furthermore, by changing the driving frequency of the AO devices between 39.6 and 35.7 MHz in 10 ms, a light source apparatus in which the oscillation wavelength is swept between 1.09 to 1.21 μm at a frequency of 100 kHz is provided. Specific examples of such a light source apparatus will be described below in sixth and seventh embodiments.

As described above, by combining a plurality of dispersing elements, light is dispersed and thus forms a plurality of beams having different wavelengths, and the dispersed beams are collimated.

The spatial modulator 108 as the selecting device configured to select a beam having a specific wavelength from among a plurality of beams will now be described.

Examples of the spatial modulator 108 include the following: an element (light valve) having one or more rows of microscopic apertures that reflect or transmit incoming beams, AO and electro-optic (EO) devices forming traveling diffraction gratings, and an element having a light-blocking member provided with a transmissive aperture through which light is transmitted.

First, a spatial modulator that does not utilize traveling waves will be described.

A spatial modulator that does not utilize traveling waves has pixels (or apertures) whose size ranges from several microns to several hundred microns, the pixels being arranged one- or two-dimensionally. Beams that strike the pixels (apertures) are either reflected in specific directions or transmitted therethrough.

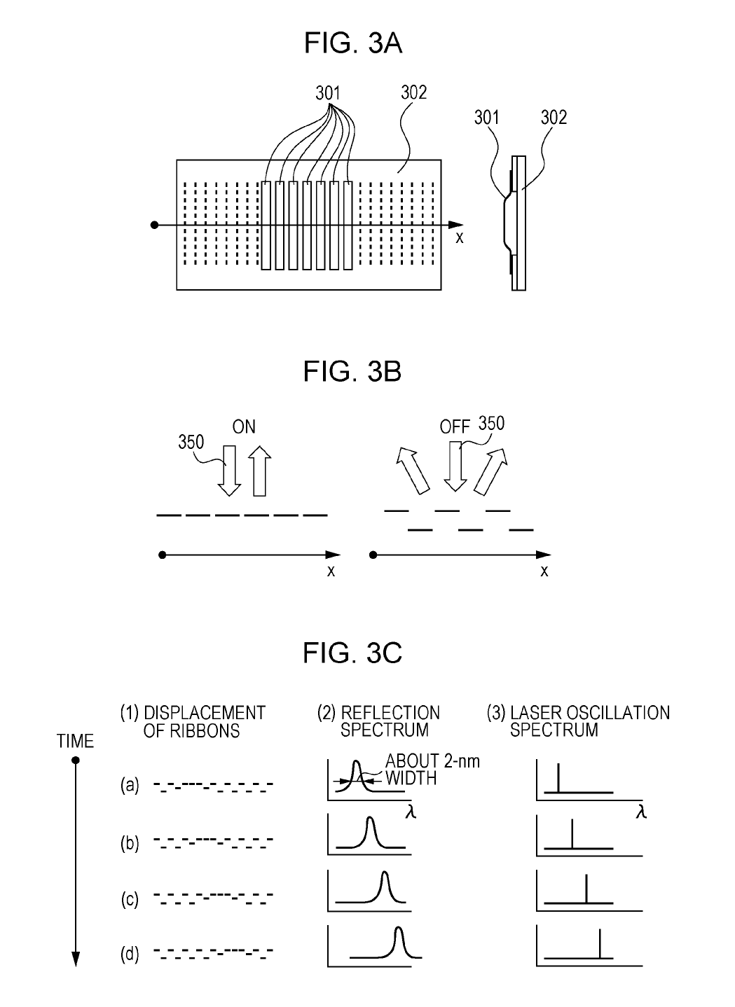

Referring to FIGS. 3A to 3C, an example of such a spatial modulator will now be described. The spatial modulator is a micro-opto-electromechanical device in which light is reflected and diffracted by metal-foil ribbons provided on a substrate.

FIG. 3A schematically shows an exemplary ribbon-type reflecting/diffracting device. The device includes a substrate 302 and ribbons 301. The ribbons 301 are electrostatic metal-foil strips each having a width of several microns and a length of several hundred microns. The ribbons 301 are arranged side by side in the x direction on the substrate 302. Several ribbons 301 form one pixel. The ribbons 301 are each bendable under an electrostatic force, making a level difference from other ribbons 301 adjacent thereto, whereby a displacement equivalent to one fourth of the wavelength λ, (λ is the wavelength of an incoming beam) is produced.

FIG. 3B includes cross-sectional views showing two different states of the ribbons 301, taken in the x direction. In this example, one pixel includes six ribbons 301. Here, suppose that a beam 350 strikes the pixel shown in FIG. 3B. In the state shown on the left in FIG. 3B, there are no differences in the levels of the six ribbons 301, and the pixel therefore functions as a mirror causing specular reflection. In contrast, in the state shown on the right in FIG. 3B, the ribbons 301 are staggered by a level difference of λ/4, and the pixel therefore functions as a phased diffraction grating. Hence, the beam 350 falling over adjacent ones of the ribbons 301 forms beams that are each reflected at a phase angle of λ/2, and the beams reflected by the adjacent ribbons 301 cancel each other out. Consequently, the pixel does not cause specular reflection.

The beam that has not been specularly reflected is diffracted. In this example, since the device functions as a spatial modulator that utilizes specular reflection, the pixel shown on the left in FIG. 3B is in the ON state, and the pixel shown on the right in FIG. 3B is in the OFF state.

FIG. 3C schematically summarizes the relationship between the displacement of the ribbons 301 of the spatial modulator and the resulting laser oscillation.

In FIG. 3C, column (1) shows different states of the ribbons 301 that change with time, column (2) shows the reflection spectra corresponding to the respective states of the ribbons 301, and column (3) shows the wavelengths of the resulting laser oscillation.

Focusing on the states of the ribbons 301 at time (a), a reflective pixel is formed at a left-of-center position in the row of ribbons 301. When a beam is reflected at the reflective pixel, the spectrum of the reflection that is fed back to the optical amplification medium has a profile including a peak spreading with a certain width corresponding to the width of the reflective pixel, as shown in column (2). When the reflection having such a spectrum is fed back to the optical amplification medium, several longitudinal modes appear within the spectrum.

However, the energy of the longitudinal modes concentrates on the wavelength at the peak of the reflection profile. Therefore, the oscillation wavelength corresponds to the wavelength at the peak of the reflection spectrum.

Focusing now on other states at times (b) to (d), the reflective pixel of ribbons 301 is shifted rightward with time, and it is understood that the oscillation wavelength changes correspondingly.

Next, the speed of wavelength sweeping performed by the wavelength-tunable light source apparatus will be described.

The displacement of the ribbons 301 are controlled at a driving frequency of about 10 MHz. Hence, to realize a sweeping speed of 100 kHz or higher with a thousand pixels, ten pixels are to be involved with the reflection spectrum. As described above, the peak of the reflection spectrum determines the wavelength of laser oscillation. Thus, a light source apparatus that operates at a sweeping speed of 100 kHz or higher is realized.

While a reflecting/diffracting element including metal-foil ribbons have been described as an example of the spatial modulator 108, the spatial modulator 108 may alternatively be a micromirror device, in which movable micromirrors are arranged one- or two-dimensionally and spatial modulation is performed by controlling the inclinations of the individual micromirrors, or a reflective liquid-crystal panel.

Next, an exemplary spatial modulator utilizing a traveling diffraction grating will be described. A traveling characteristic is that, for example, waves of compression and rarefaction of the refractive index or a wavy pattern in a surface spatially travels and propagates through a propagation medium. The following description concerns examples employing AO and EO devices.

In such a spatial modulator, the AO or EO device is controlled to be driven in such a manner as to form, in the propagation medium, a traveling diffraction grating including a portion (at least one pixel) where there are no compression and rarefaction of the refractive index. The portion of the traveling diffraction grating where there are no compression and rarefaction of the refractive index functions as the ON pixel of the spatial modulator.

A beam of light radiated from an optical amplification medium is dispersed and collimated by the two diffraction gratings, whereby beams having different wavelengths are obtained. Thus, beams parallel to one another strike the spatial modulator. Portions of the spatial modulator where the traveling diffraction grating is formed function as the OFF pixels, and a portion of the spatial modulator where the traveling diffraction grating is not formed functions as the ON pixel by transmitting or reflecting the incoming beam. In a case where the device is of reflective type, the beam is reflected by the ON pixel and is fed back to the optical amplification medium. In a case where the device is of transmissive type, the beam is transmitted through the ON pixel, is reflected by a mirror provided behind the pixels, and is fed back to the optical amplification medium. The ON pixel at which there are no compression and rarefaction of the refractive index travels through the propagation medium at a high speed specific to the medium. Thus, a sweeping speed of 100 kHz or higher is realized.

A spatial modulator employing an acousto-optic (AO) device will now be described. An AO modulator is a combination of an AO device and a mirror that reflects light transmitted through the AO device. The mirror functions as one of the components forming the resonator included in the light source apparatus.

Referring now to FIG. 5A, Raman-Nath diffraction, the principles of modulation by the AO device, will be described. As described for Bragg diffraction, when the ultrasonic oscillator 53 is driven, waves 54 of compression and rarefaction of the refractive index travel through the crystalline medium 50 of the AO device. In Raman-Nath diffraction also, the grating pitch P is expressed as Equation (8) on the basis of the driving frequency f_{c} and the speed v m/s of the ultrasonic oscillation traveling through the crystalline medium 50.

In Raman-Nath diffraction, the incidence angle θ in Equation (1) is zero, and the relationship among the speed v of propagation of the ultrasonic wave, the driving frequency f_{c}, and the diffraction angle φ_{R} is expressed as follows:

$$\begin{matrix}[ Math . 11 ] & \\ {φ}_{R} = \frac{{f}_{c} \cdot λ}{v} & ( 10 )\end{matrix}$$

For example, when the wavelength λ is 1.15 μm; the speed v of propagation of the ultrasonic wave is 3300 m/s; and the driving frequency f_{c} is 80 MHz, the angle of ±1st-order diffracted beams is 1.6°.

FIG. 5B shows the distribution of compression and rarefaction of the refractive index. In FIG. 5B, the direction in which the ultrasonic wave travels through the crystalline medium 50 of the AO device is defined as the x direction. Beams of light strike the AO device as indicated by the arrows. In FIG. 5B, the beam that strikes a portion (pixel) where the refractive index is constant with no compression and rarefaction is transmitted through the AO device as a 0th-order diffracted beam.

Meanwhile, the beams that strike portions where there is a periodic distribution of the refractive index undergo Raman-Nath diffraction, producing ±1st-order, ±2nd-order, . . . diffracted beams. The ±1st- and higher-order diffracted beams can be blocked by an aperture or the like so as not to be fed back to the optical amplification medium, as described below in a fourth embodiment.

If a mirror is provided behind the transmissive portion of the AO device, the AO device, in combination with the mirror, can function as a reflective spatial modulator.

Next, an exemplary laser oscillation produced by a wavelength-tunable light source apparatus employing the above AO device as the spatial modulator will be described.

The ON pixel shown in FIG. 5B travels with time in the form of compression and rarefaction of the refractive index, in a manner similar to that described above referring to FIGS. 3A to 3C. When a beam is reflected by the ON pixel, the spectrum of the reflection that is fed back to the optical amplification medium has a profile including a peak spreading with a certain width corresponding to the width of the ON pixel. When the reflection having such a spectrum is fed back to the optical amplification medium, several longitudinal modes appear within the reflection spectrum. However, the energy of the longitudinal modes concentrates on the wavelength at the peak of the reflection profile. Therefore, the oscillation wavelength corresponds to the wavelength at the peak of the reflection spectrum.

A specific example of the sweeping speed will be given. Supposing that the dispersion width Δ is 3.1 mm and the speed of travel of the ultrasonic wave is 3300 m/s, a high sweeping speed of 1100 kHz is realized.

Other examples of the spatial modulator employing the traveling diffraction grating include an EO device utilizing the piezoelectric effect, and a surface-acoustic-wave device utilizing the surface acoustic wave.

In a case where the above-described spatial modulator includes reflective pixels, the spatial modulator also functions as one of the resonator components between which the optical amplification medium is provided in the optical path.

Examples of the optical amplification medium according to the general embodiment of the present invention that amplifies light include an active layer of a semiconductor laser, an active layer of a semiconductor optical amplifier (SOA), a rare-earth-doped (ion-doped) optical fiber containing, for example, erbium or neodymium, and a medium that amplifies light by utilizing a dye doped to an optical fiber.

An SOA utilizes the process of optical amplification basically with no resonator components provided on a semiconductor laser. The end faces of the SOA have low reflectivity so as not to form any resonator component.

In the light source apparatus according to the general embodiment of the present invention, an optical amplification medium is provided inside a resonator. Therefore, one end face of the SOA can be provided as a mirror, and the other end face can be anti-reflection-coated so that light is efficiently emitted toward the first device, i.e., the dispersing element. In such a configuration, one end face of the SOA has a cleavage plane functioning as one of the resonator components and as an output surface of the light source apparatus. Alternatively, a semiconductor laser having one end face thereof anti-reflection-coated may be employed.

Semiconductor lasers and SOAs are of small sizes and are controllable at high speeds, and are therefore beneficial in terms of the size reduction and high-speed control of the light source apparatus.

The active layers of semiconductor lasers and SOAs may be compound semiconductors or the like employed in general semiconductor lasers. Exemplary compound semiconductors include those based on InGaAs, InAsP, GaAlSb, GaAsP, AlGaAs, GaN, and the like. Such an active layer is to be selected from among those having gain center wavelengths of 840 nm, 1060 nm, 1150 nm, 1300 nm, 1550 nm, etc., in accordance with the intended use and so forth of the light source apparatus.

Rare-earth-doped optical fibers are suitable for obtaining a high gain with a good noise characteristic. Dye-doped optical fibers are beneficial in that an increased number of wavelength options are provided by appropriately selecting the fluorescent dye and the host material.

The scope of the present invention includes an optical-coherence-tomography (OCT) system.

An OCT system according to the general embodiment of the present invention includes the light source apparatus according to the general embodiment of the present invention.

Now, the relationship between the swept wavelength range and the resolution in the thickness direction of the sample and the relationship between the sampling pitch at which the wavelength is swept and the detectable length in the depth direction of the sample in the OCT system will be described.

The sampling wavelength interval Δλ at which the wavelength is swept and the maximum length L in the depth direction of the sample (in the optical-axis direction) detectable with the OCT system have the following relationship, in principle:

$$\begin{matrix}[ Math . 12 ] & \\ L = \frac{{λ}^{2}}{Δλ} & ( 11 )\end{matrix}$$

Letting the upper and lower limits of the swept wavelength range be denoted by λ₁ and λ₂, respectively, the resolution ΔL in the depth direction of the sample (in the optical-axis direction) detectable with the OCT system is expressed as follows:

$$\begin{matrix}[ Math . 13 ] & \\ Δ L = \frac{{λ}_{1} \cdot {λ}_{2}}{2 ( {λ}_{1} - {λ}_{2} )} & ( 12 )\end{matrix}$$

Specifically, supposing that the sampling wavelength interval Δλ is 0.15 nm and the center wavelength λ is 1.15 μm, the maximum detectable length L in the depth direction of the sample (in the optical-axis direction) is calculated to be 8.8 mm from Equation (11).

Furthermore, supposing that the upper and lower limits λ₁ and λ₂ of the swept wavelength range are 1.09 μm and 1.21 μm, respectively, the detectable resolution ΔL in the depth direction of the sample (in the optical-axis direction) is calculated to be 5.5 μm.

Now, the present invention will be described in more detail by giving several specific embodiments. To avoid redundancy, elements that are the same as or similar to those described above are basically denoted by common reference numerals.

### First Embodiment and Comparative Embodiment

FIG. 1 schematically shows a light source apparatus according to a first embodiment of the present invention including two transmissive diffraction gratings.

Referring to FIG. 1, the optical amplifier 101 produces laser oscillation. The active layer 102 functions as the optical amplification medium. The end face 103 of the optical amplifier 101 is a translucent mirror so as to function as a resonator mirror and to extract the output beam 113.

The end face 104 of the optical amplifier 101 is anti-reflection-coated. The active layer 102 radiates and emits the beam 110 to the outside with a specific range of wavelength that depends on the gain width of the active layer 102.

The optical system 105 shapes the beam 110 emitted to the outside and focuses the beam 110 on the spatial modulator 108.

The first diffraction grating 106 disperses the beam 110 and thus produces beams having different wavelengths. The second diffraction grating 107 collimates the dispersed beams having different wavelengths. The grating pitches of the diffraction gratings 106 and 107 are both 1.5 μm. The diffraction gratings 106 and 107 are provided parallel to each other and are spaced apart from each other by a distance of 15 mm.

As a result of the dispersion, a beam 111 having a long wavelength and a beam 112 having a short wavelength are obtained. The mirror 109 reflects a beam having a specific wavelength selected by the spatial modulator 108 back to the active layer 102.

In the first embodiment, the active layer 102 of the optical amplifier 101 includes InGaAs layers and GaAs layers that are alternately stacked into a quantum well structure having a thickness of 1 μm.

When electrical energy is supplied to the active layer 102 of the optical amplifier 101, optical radiation occurs. The radiation is amplified in the active layer 102 and propagates toward the end face 103, functioning as a resonator component, and the anti-reflection-coated end face 104. The radiation is transmitted through the anti-reflection-coated end face 104 and is emitted as the beam 110 to the outside. The beam 110 has astigmatism and the wavefronts thereof are asymmetric with respect to the optical axis. The beam 110 is then converted by the optical system 105 into a beam in the form of spherical waves that are symmetric with respect to the optical axis. The beam 110 in the form of spherical waves is dispersed and thus forms beams having different wavelengths by being transmitted through the diffraction grating 106. The dispersed beams are collimated by being transmitted through the diffraction grating 107. The collimated beams are focused on the spatial modulator 108.

The beam 110 of the radiation from the active layer 102 perpendicularly strikes the diffraction surface of the diffraction grating 106. That is, the incidence angle θ₁ is zero. As expressed by Equations (1) to (6), the emergence angle φ₂ of the beams emerging from the diffraction grating 107 is also zero.

When the output beam 113 emitted from the end face 103, i.e., the translucent mirror, is measured with an optical spectrum analyzer, a laser beam having a center wavelength of 1.15 μm with a swept wavelength range of 1.09 to 1.21 μm is detected.

The diffraction angles produced with the center wavelength of 1.15 μm, the short wavelength end of 1.09 μm, and the long wavelength end of 1.21 μm are calculated to be 50.1°, 46.6°, and 53.8°, respectively, from Equation (3). The width Δ between the short wavelength end and the long wavelength end is calculated to be 4.6 mm from Equation (7).

Now, a comparative embodiment corresponding to a known light source apparatus will be described.

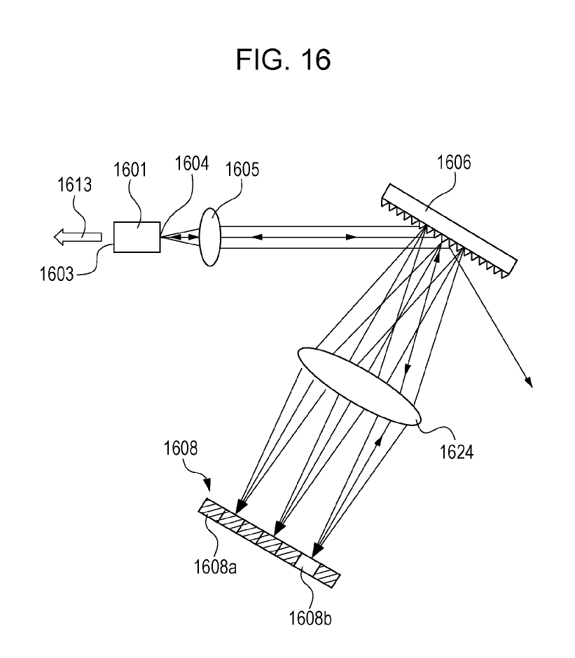

The comparative embodiment corresponds to the light source apparatus shown in FIG. 16. Let the focal length of the focusing lens 1624 shown in FIG. 16 be denoted by fₒ, and the focal length of the lens 1605, which is a beam-shaping lens, provided near the laser medium 1601, corresponding to the optical amplifier, be denoted by f_{b}. Furthermore, suppose that the thickness of the active layer of the optical amplifier 1601 is 0.001 mm. Furthermore, let the stabilities of the focusing lens 1624 in the optical-axis direction and in the direction perpendicular to the optical axis under the aforementioned conditions be denoted by δz and δy, respectively.

When the focusing lens 1624 is displaced by δz or δy, each beam is deflected and strikes a position deviating from the originally expected position by δθ. To cause this beam deflected by δθ to be fed back to the active layer, since the distance from the center of the active layer to each boundary is 0.0005 mm, the following equation is to be satisfied:

δθ·f_{b}=0.005 (mm) [Math. 14]

Here, supposing that f_{b} is 3 mm, the following holds:

[Math. 15]

θθ=0.00017 (mm) (13)

The allowances for δz and δy will now be calculated. First, δz will be considered. Letting the width of the set of beams be denoted by Δ as described above, δθ is expressed as follows, as a function of δz:

$$\begin{matrix}[ Math . 16 ] & \\ δθ = {tan}^{- 1} ( \frac{\frac{Δ}{2}}{{f}_{o} + δ z} ) - {tan}^{- 1} ( \frac{\frac{Δ}{2}}{{f}_{o}} ) & ( 14 )\end{matrix}$$

Then, δy is expressed as follows:

[Math. 17]

δθ=fₒ·δy (15)

Here, suppose that Δ is 4.6 mm and fₒ is 15 mm. This is equivalent to a case where the diffraction grating 107 according to the first embodiment is replaced with the focusing lens 1624.

From Equations (13) to (15), the following values are obtained:

δz=0.017 mm [Math. 18]

δy=0.000013 mm [Math. 19]

According to the above calculations, it is understood that, in the known light source apparatus employing the focusing lens 1624, the positional allowances of the optical axis in the z and y directions are 17 μm or smaller and 0.013 μm (13 nm) or smaller, respectively.

The allowance in the y direction is particularly strict, requiring nanometer-order precision.

In contrast, in the light source apparatus according to the first embodiment of the present invention, since the dispersed beams are collimated by a non-focusing optical element (diffraction grating), the allowances δz and δy in the z and y directions are theoretically not limited but are practically limited only by mechanical interferences.

That is, in the light source apparatus according to the first embodiment of the present invention, oscillation is produced over the entirety of the swept range, and difficult works of very precise measurement and very strict positioning are not necessary for realizing stable light intensity. Therefore, the light source apparatus is manufactured easily.

### Second Embodiment

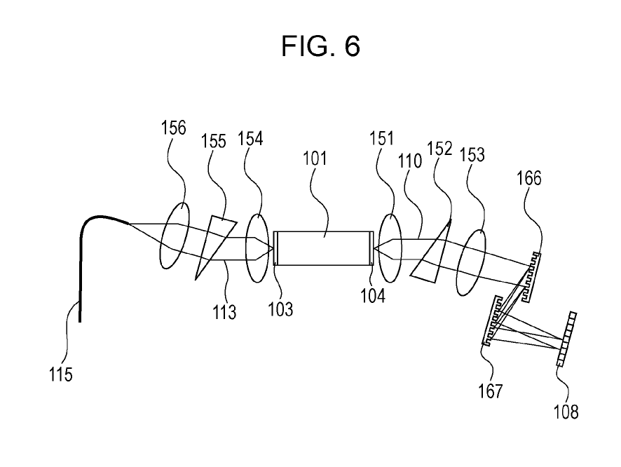

Referring to FIG. 6, a light source apparatus according to a second embodiment of the present invention will now be described.

The second embodiment concerns an apparatus employing blazed reflective diffraction gratings, which realize high diffraction efficiency. In addition to the high efficiency of light utilization, the light source apparatus according to the second embodiment is beneficial in that the size thereof in the optical-axis direction is shorter because the optical path is folded by the use of the reflective diffraction gratings.

A reflective blazed diffraction grating 166 disperses the beam 110 emitted from the optical amplifier 101. A reflective blazed diffraction grating 167, which is of the same kind as the reflective blazed diffraction grating 166, collimates the dispersed beams having different wavelengths obtained from the beam 110. The spatial modulator 108 includes metal-foil ribbons. Among the beams received at different portions of the spatial modulator 108, a beam having a specific wavelength is selected and is fed back to the active layer.

A collimator 151 collimates the beam 110 having an oval shape emitted from the active layer. A beam-shaping prism 152 shapes the oval beam 110 into a circular shape, thereby converting the beam 110 into a beam in the form of a plane wave. A focusing lens 153 focuses the beam 110 in the form of a plane wave on the spatial modulator 108.

The end face 103 of the optical amplifier 101 forms a mirror on the output side functioning as one of the resonator components. The output beam 113 emitted from the end face 103 is transmitted through a collimator lens 154, a beam-shaping prism 155, and a coupling lens 156, and enters a fiber 115.

In a case where the reflective blazed diffraction gratings 166 and 167 each have 600 grooves/mm at a blazed angle of 30°, the efficiency of the 1st-order diffracted beam is 80% or higher.

When two reflective blazed diffraction gratings are employed as the dispersing element and the collimating element, high diffraction efficiency is realized. In addition, the optical path is folded. Therefore, the light source apparatus is provided with excellent wavelength controllability and in a smaller size with a reduced length.

### Third Embodiment

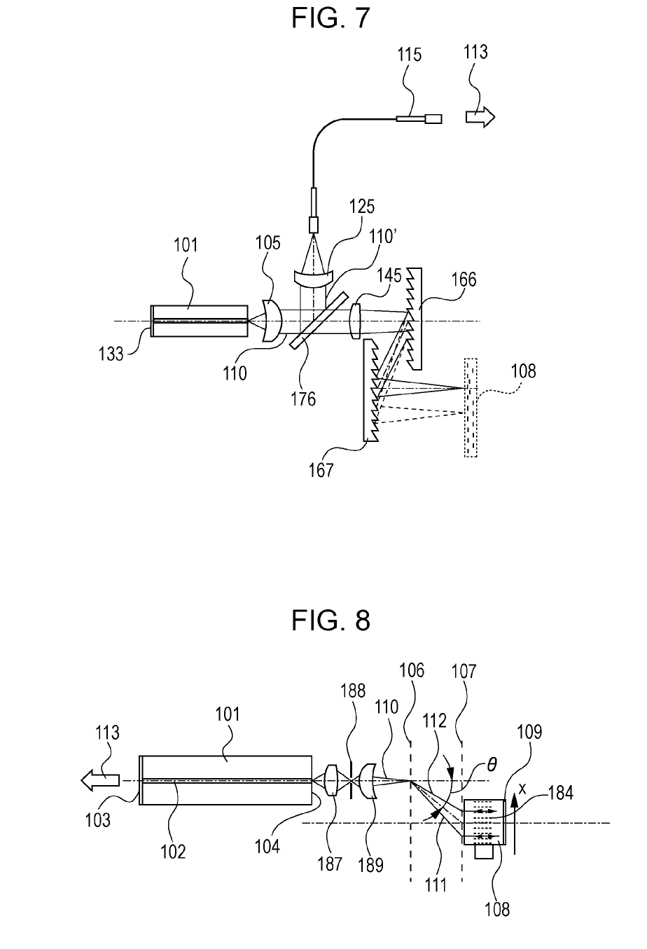

Referring to FIG. 7, a light source apparatus according to a third embodiment of the present invention will now be described.

The apparatus according to the third embodiment has a shorter length in the optical-axis direction than the apparatus according to the second embodiment.

The apparatus according to the third embodiment employs a folded optical system with two reflective blazed diffraction gratings, as in the second embodiment, and includes a translucent mirror 176 provided between the optical amplifier 101 and the reflective blazed diffraction grating 166, whereby the output beam 113 is extracted in a direction away from the optical axis defined by the optical amplifier 101. Thus, compared with the second embodiment in which lenses are provided on the output side on the extension of the optical axis defined by the optical amplifier, a further size reduction is realized.

In addition, since an optical amplifier emitting light only from one end face thereof is employed, a practically low-cost light source apparatus is provided.

In the apparatus shown in FIG. 7, the beam 110 emitted from the optical amplifier 101 is collimated by the optical system 105. A portion of the collimated beam 110 is transmitted through the translucent mirror 176, whereas the remaining portion of the collimated beam 110 is reflected by the translucent mirror 176 and, as a beam 110′, travels toward the fiber 115.

The transmitted portion of the beam 110 is focused by a focusing lens 145 while being reflected by the reflective blazed diffraction gratings 166 and 167 in the form of beams having different wavelengths. The beams having different wavelengths are thus focused on different pixels of the spatial modulator 108 also functioning as a resonator component. The pixels of the spatial modulator 108 each include, for example, metal-foil ribbons.

A beam having a specific wavelength is selected and reflected by the spatial modulator 108. The beam is further reflected by the reflective blazed diffraction gratings 167 and 166 again. Subsequently, the beam is transmitted through the translucent mirror 176 and enters the optical amplifier 101, thereby being amplified.

The beam amplified by the optical amplifier 101 is reflected by an end face 133 of the optical amplifier 101, is further amplified, and, as the beam 110, travels toward the optical system 105. The transmittance of the translucent mirror 176 is specified such that laser oscillation is produced even if there is any loss of energy due to the reflection and absorption by the translucent mirror 176.

Laser oscillation is produced with the beam having the selected wavelength obtained by the repetition of the above process. A portion of the beam is reflected by the translucent mirror 176, is transmitted through a focusing lens 125, and is guided into the fiber 115.

In the above configuration, the amplified beam is guided, as the beam 110′, in a direction away from the optical axis of the beam 110 (in the third embodiment, a direction substantially perpendicular to the optical axis of the beam 110), and is extracted as the output beam 113.

Thus, compared with the apparatus according to the second embodiment in which lenses are provided on the output side on the extension of the optical axis defined by the optical amplifier, the size of the apparatus according to the third embodiment is further reduced. In addition, since an optical amplifier emitting light only from one end face thereof is employed, a low-cost light source apparatus is provided.

### Fourth Embodiment

A light source apparatus according to a fourth embodiment of the present invention is the same as the light source apparatus according to the first embodiment, except that the spatial modulator 108 is an acousto-optic (AO) device.

The principles of the spatial modulator employing an AO device has been described in detail in the general embodiment.

Specifically, a traveling diffraction grating including a portion (at least one pixel) where there are no compression and rarefaction of the refractive index is formed in the propagation medium. The portion where there are no compression and rarefaction of the refractive index is utilized as the ON pixel, and the other portions where the traveling diffraction grating is formed are utilized as the OFF pixels.

Description will proceed with reference to FIG. 8. In FIG. 8, elements that are the same as or similar to those shown in FIG. 1 are denoted by common reference numerals.

The beam 110 emitted from the optical amplifier 101 undergoes dispersion and collimation by the two diffraction gratings 106 and 107. The resulting beams having different wavelengths enter the spatial modulator 108.

Waves 184 of compression and rarefaction of the refractive index travel through the propagation medium of the AO device. Portions where the traveling diffraction grating is formed function as the OFF pixels, and a portion where the traveling diffraction grating is not formed functions as the ON pixel, where the beam is transmitted or reflected.

In a case where the device is of reflective type, the beam selected at the ON pixel is fed back to the active layer 102, i.e., the optical amplification medium. In a case where the device is of transmissive type, the selected beam is fed back to the active layer 102 by the mirror 109 provided behind the device. The ON pixel travels through the medium at a high speed specific to the medium. Thus, a sweeping speed of 100 kHz or higher is realized.

An optical system 187 shapes and condenses the oval beam 110 from the active layer 102 into a circular beam. Although the optical system 187 shown in FIG. 8 includes one lens, the optical system 187 may include a plurality of lenses.

An aperture 188 blocks the unintended diffracted beams from the AO device. A focusing lens 189 focuses the beam 110 diverging from the aperture 188 on the mirror 109 provided behind the AO device, i.e., the spatial modulator 108. The mirror 109 functions as a resonator component.

The anti-reflection-coated end face 104, which is an output end of the active layer 102, and the mirror 109, functioning as a resonator component, are optically conjugate to each other, whereas the aperture 188 and the mirror 109 are not conjugate to each other. Therefore, the diffracted beams from the AO device other than the 0th-order diffracted beam, i.e., the ±1st- or higher-order diffracted beams, are blocked by the aperture 188 and are not fed back to the active layer 102.

The active layer 102 in the fourth embodiment is the same as that in the first embodiment. The diffraction gratings 106 and 107 in the fourth embodiment are also the same as those in the first embodiment, except that the distance therebetween is 10 mm.

Thus, a laser beam having a center wavelength of 1.15 μm with a swept wavelength range of 1.09 to 1.21 μm is produced.

The size of the crystal as the medium of the AO device is limited. Therefore, the distance d between the diffraction gratings 106 and 107 is set to 10 mm. Accordingly, the dispersion width Δ between the short wavelength end and the long wavelength end is calculated to be 3.1 mm from Equation (7).

Supposing that the speed of travel of the wave through the AO device is 3300 m/s and the driving frequency of the AO device is 80 MHz, the diffraction angle of the 1st-order diffracted beam having a wavelength of 1.15 μm is 1.6°.

By determining the diameter of the aperture 188 and the focal length of the focusing lens 189 such that at least the ±1st-order diffracted beams are blocked, a swept light source apparatus operating at a high sweeping speed of 1 MHz or greater is provided.

### Fifth Embodiment

A fifth embodiment of the present invention concerns a light source apparatus employing a surface-acoustic-wave (SAW) device as the spatial modulator.

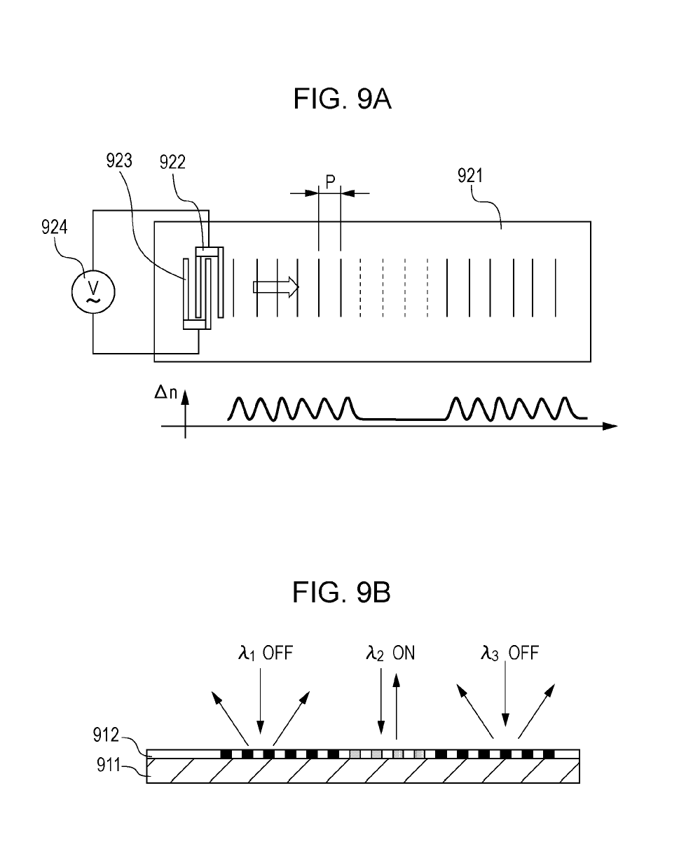

FIGS. 9A and 9B schematically show a SAW device.

In the SAW device, since the speed of the surface acoustic wave is as high as 4000 m/s, a sweeping speed corresponding to a sweeping frequency of 1 MHz or higher is realized. Furthermore, since the SAW device is thinner than the AO device, a smaller light source apparatus is provided.

The principles of the spatial modulator employing the SAW device are similar to those of the AO device described in the fourth embodiment.

When ultrasonic oscillation is produced by placing a high-frequency voltage across electrodes, a traveling diffraction grating travels through the SAW device. The SAW device is driven intermittently by taking pauses periodically.

Such a driving method produces a traveling diffraction grating including a portion, corresponding to about one pixel, where there are no compression and rarefaction of the refractive index and the surface shape. The portion functions as the ON pixel. That is, a beam having a wavelength corresponding to the position of the ON pixel is selected and is reflected as the 0th-order beam by the interface between the ON pixel and a substrate carrying the ON pixel.

The interface functions as a mirror, i.e., one of the resonator components. The reflected beam is fed back to the active layer 102, and laser oscillation is produced with the wavelength of the feedback beam.

Meanwhile, in the portions where there are compression and rarefaction of the refractive index and the surface shape, diffraction occurs but no 0th-order reflection occurs. Hence, the portions function as the OFF pixels. The diffracted beams, other than the 0th-order beam, from the OFF pixels are fed back toward the active layer 102 but are blocked by an aperture provided halfway in the optical path or by the aperture of the active layer 102. Therefore, such diffracted beams do not contribute to laser oscillation.

Elements shown in FIG. 9A include a SAW device 921, electrodes 922 and 923 that generate surface-acoustic waves, and a drive power circuit 924 that places a voltage across the electrodes 922 and 923.

FIG. 9B is a schematic cross-sectional view of the SAW device 921.

A piezoelectric thin film 912 is composed of, for example, lithium niobate (LiNbO₃), and has an absolute refractive index nₒ of 2.232 and an effective refractive index nₑ of 2.156.

A substrate 911 carries the piezoelectric thin film 912. The interface between the substrate 911 and the piezoelectric thin film 912 functions as a reflective film that reflects the incoming beam having a wavelength within the swept wavelength range.

When a high-frequency alternating voltage is placed across the electrodes 922 and 923, surface acoustic waves representing the compression and rarefaction of the refractive index and the surface shape propagate on the surface of the SAW device 921 at a speed of 4000 m/s.

Supposing that the electrodes 922 and 923 each having a width of 1 μm are provided with a separation of 1 μm, surface waves occurring at a pitch P of 4 μm propagate. In this case, the diffraction angle of the ±1st-order diffracted beams is ±16.7°.

Furthermore, suppose that the change in the refractive index of the piezoelectric thin film 912, for example, a lithium niobate film, occurring when a voltage is placed across the electrodes 922 and 923 is 0.024, and that the depth to which the refractive index changes is the threefold of the wavelength of 4 μm, i.e., 12 μm. Then, the difference in optical path length between before and after the change is 0.288 μm, which is equivalent to λ/4, where λ is the wavelength of the incoming beam and is 1.15. Therefore, the intensity of the 0th-order diffracted beam under such a situation is zero.

### Sixth Embodiment

In each of the above embodiments, two static diffraction gratings are employed for dispersing the light radiated from the optical amplification medium and thus producing beams having different wavelengths and for collimating the dispersed beams. In a sixth embodiment of the present invention, traveling diffraction gratings (diffraction gratings utilizing traveling waves) that are temporally and spatially dynamic are employed.

The basic concept of the traveling diffraction grating has been described above in the general embodiment.

In the sixth embodiment, a beam having a wavelength with which Bragg diffraction at a specific angle is caused by the AO device is selected and is fed back to the optical amplification medium, and laser oscillation is produced.

According to Equation (9), when the driving frequency f_{c} of the AO device is swept, is swept because the Bragg diffraction angle θ_{B} is fixed. Thus, a swept light source apparatus is provided.

In the sixth embodiment in which two AO devices are employed, the Doppler shifts of the wavelength caused by the two traveling diffraction gratings cancel each other out.

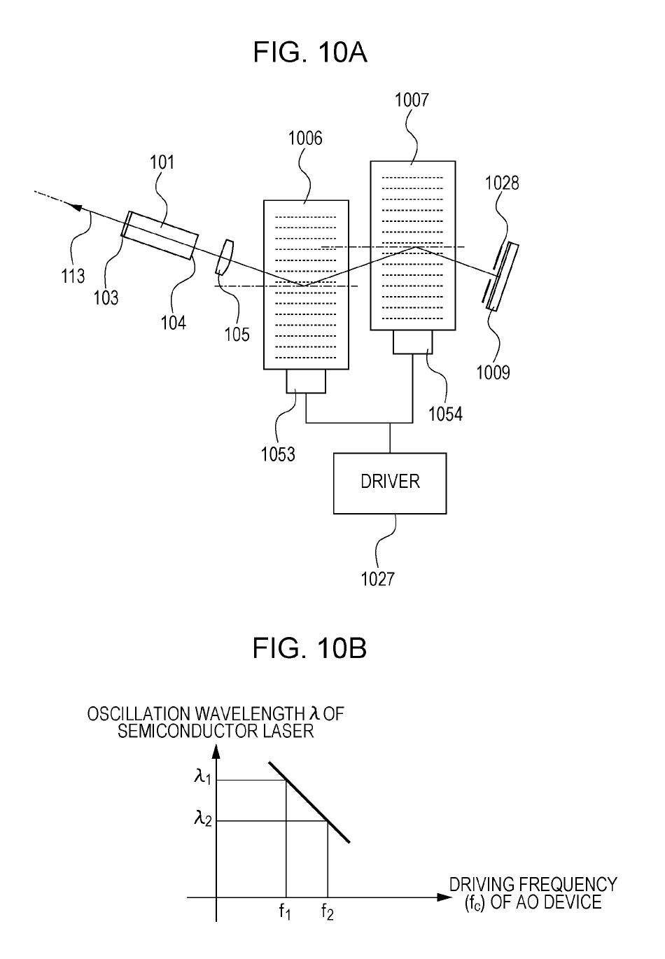

An apparatus according to the sixth embodiment will now be described with reference to FIG. 10A. The apparatus shown in FIG. 10A includes a first AO device 1006 that disperses the beam of light radiated from the optical amplification medium and thus produces a plurality of beams, and a second AO device 1007 that collimates the beams resulting from the dispersion by the first AO device 1006.

The distances from the positions of diffraction in the first and second AO devices 1006 and 1007 to respective oscillators 1053 and 1054 are set so as to be equal, whereby waves of compression and rarefaction at the same pitch reach the respective positions of diffraction.

A driver 1027 drives the first and second AO devices 1006 and 1007 simultaneously. An aperture 1028 is provided for selecting a beam having a specific wavelength from among the beams collimated by the second AO device 1007. A mirror 1009 and the end face 103 of the optical amplifier 101 in combination function as a resonator.

The optical system 105 is a focusing lens that focuses the beam from the optical amplifier 101 on the mirror 1009.

The operation according to the sixth embodiment will now be described.

First, the AO devices 1006 and 1007 are driven by the driver 1027 at a frequency f₁. Subsequently, electrical energy is supplied from a power source (not shown) to the optical amplifier 101, whereby a beam of light radiated from the optical amplifier 101 travels through the focusing lens 105 and enters the first AO device 1006.

The relationship between the diffraction angle (Bragg diffraction angle) and the wavelength of each of the diffracted beams produced at the entry into the first AO device 1006 is expressed by Equation (9) above. That is, the incidence angle on the first AO device 1006 corresponds to the Bragg diffraction angle θ_{B}.

As can be seen from FIG. 10A, θ_{B} is fixed. Let the wavelength of the beam Bragg-diffracted by the first AO device 1006 be denoted by λ₁. The Bragg-diffracted beam enters the second AO device 1007 that is being driven at the same frequency as for the first AO device 1006, and the beam is similarly Bragg-diffracted.

Subsequently, the beam having the wavelength λ₁ is selected (the wavelength range is limited) by the aperture 1028 and strikes the mirror 1009. The beam having the wavelength λ₁ is reflected by the mirror 1009, returns the same optical path, and enters the active layer of the optical amplifier 101. Thus, the beam is amplified between the mirror 1009 and the end face 103, which is a translucent mirror.

The beam reflected by the translucent mirror 103 travels back and forth between the translucent mirror 103 and the mirror 1009, thereby being amplified. Then, an output beam 113 having the wavelength λ₁ is output through the translucent mirror 103.

Subsequently, the driving frequency of the driver 1027 is changed to f₂. This changes the pitch of the diffraction gratings, i.e., the pitch of the compression and rarefaction of the refraction index.

Since the Bragg diffraction angle θ_{B} is fixed, the diffraction wavelength changes to λ₂ in accordance with Equation (9). This change is schematically shown in FIG. 10B.

Now, the Doppler shifts caused by the first and second AO devices 1006 and 1007 will be described.

In general, a traveling diffraction grating causes a Doppler shift acting on the wavelength of each diffracted beam. The diffraction by the first AO device 1006 occurs in the direction of travel of the wave. Hence, the frequency of the diffracted beam is increased by the driving frequency f₁ of the first AO device 1006.

Meanwhile, the diffraction by the second AO device 1007 occurs in the direction opposite to the direction of travel of the wave. Hence, the frequency of the diffracted beam is increased by −f₁, or is reduced by f₁.

Therefore, by combining the diffractions occurring in the same as and the opposite to the direction of travel of the wave of the AO devices 1006 and 1007, the Doppler shifts occurring in the AO devices 1006 and 1007 cancel each other out, and stable laser oscillation is realized.

Specific numerical values will now be given.

Suppose that the speed of propagation of the ultrasonic wave through the crystalline medium of the AO device is 3300 m/s; the Bragg diffraction angle is 35 mrad) (2°); and the same active layer as in the first embodiment is employed, whereby λ₁ and λ₂ are set to 1.21 μm and 1.09 μm, respectively. When the foregoing values are substituted into Equation (9), f₁ comes to 35.7 MHz, and f₂ comes to 39.6 MHz.

Thus, the wavelength of laser oscillation is changeable over the range of 1.21 to 1.09 μm by changing the driving frequency of the AO devices over the range of 35.7 to 39.6 MHz.

For example, if the driving frequency is continuously changed from f₁ to f₂ in a sawtooth manner at a period of 10 μs, a swept light source apparatus operating at 100 kHz is provided.

Furthermore, in the sixth embodiment, the element corresponding to the spatial modulator is provided as a light-blocking member having an aperture. Thus, a low-cost swept light source apparatus is provided.

### Seventh Embodiment

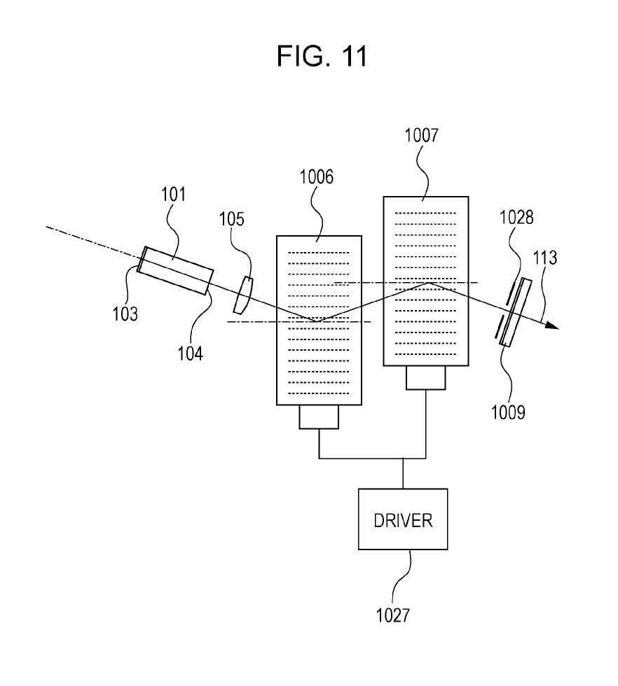

FIG. 11 schematically shows a light source apparatus according to a seventh embodiment of the present invention. The light source apparatus shown in FIG. 11 is basically the same as the light source apparatus according to the sixth embodiment, except that the output beam 113 is emitted from the opposite side, i.e., from the mirror 1009.

Specifically, unlike the apparatus shown in FIG. 10A, the end face 103 of the optical amplifier 101 functioning as one of the resonator components is provided as a mirror, and the mirror 1009 functioning as the other resonator component is a translucent mirror.

In the seventh embodiment, a side of the apparatus near the AO device corresponds to the output side, and an easily available optical amplifier having a mirror only on one side is employed. Therefore, a swept light source apparatus that costs less than the apparatus according to the sixth embodiment is provided.

### Eighth Embodiment

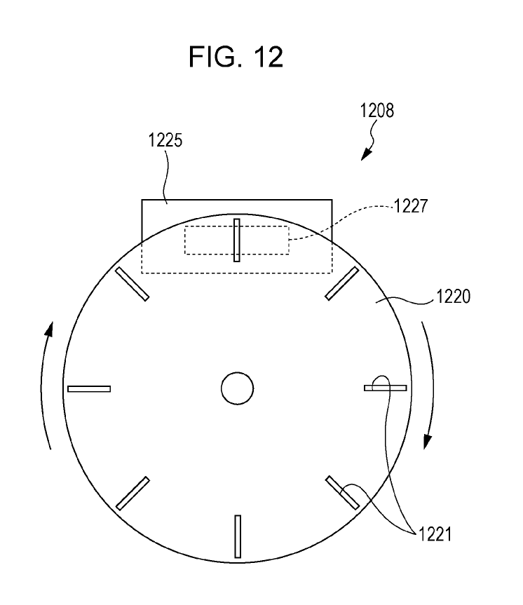

A light source apparatus according to an eighth embodiment of the present invention employs a rotatable slit (slit wheel) 1208, shown in FIG. 12, instead of the spatial modulator 108 included in the apparatus according to the first embodiment. The rotatable slit 1208 shown in FIG. 12 includes a rotatable disc 1220 having a plurality of transmissive slits 1221. The slits 1221 are arranged at regular intervals along the circumference of the rotatable disc 1220 such that the virtual lines extending in the longitudinal directions thereof pass the center of rotation of the rotatable disc 1220. The rotatable slit 1208 also includes a mirror (resonator mirror) 1225 provided behind the rotatable disc 1220. In this apparatus, as the slits 1221 sequentially pass a light dispersion area 1227, a beam having a specific wavelength that is present within the light dispersion area 1227 is continuously selected. The selected beam is reflected by the mirror 1225, whereby oscillation is produced (wavelength sweeping is performed).

While the eighth embodiment employs the transmissive slits 1221, the slits 1221 may alternatively be of reflective type so that the functions of the slits 1221 and the resonator mirror 1225 may be integrated.

### Ninth Embodiment

A ninth embodiment of the present invention concerns a light source apparatus employing a fiber ring laser.

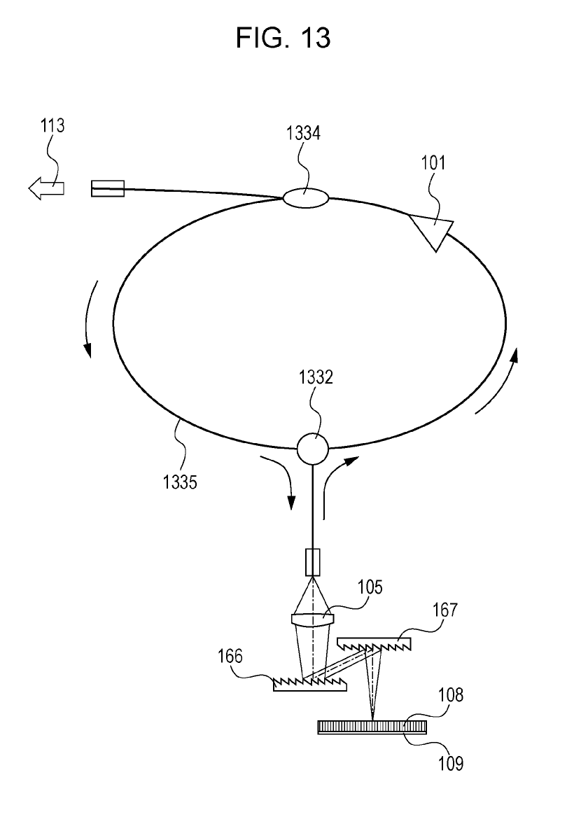

Referring to FIG. 13, the apparatus includes a fiber 1335 functioning as a waveguide, a circulator 1332 that controls the directivity of the optical path, the optical amplifier 101, and a coupler 1334 that separates light so as to extract the output beam 113.

The optical amplifier 101 is, for example, a semiconductor optical amplifier or a rare-earth-doped optical fiber.

The beam emitted from the optical amplifier 101 is separated by the coupler 1334 into two beams, one of which is guided into the fiber on the output side, and the other of which is guided into the fiber 1335. The beam guided into the fiber 1335 travels through the circulator 1332 and the optical system 105, functioning as a focusing lens, and is further guided toward the two diffraction gratings 166 and 167. The spatial modulator 108 and the mirror 109 are the same as those in any of the above embodiments.

The beam having a specific wavelength selected by the spatial modulator 108 is fed back to the circulator 1332 and is amplified in the optical amplifier 101 again. After the repetition of this process for amplifying the beam, an output beam 113 is emitted.

In the apparatus according to the ninth embodiment, the use of the fiber waveguide stabilizes the optical path, excluding any fluctuations due to the airflow. Thus, a swept light source apparatus whose output is extremely stable is provided.

### Tenth Embodiment

A tenth embodiment of the present invention concerns an optical-coherence-tomography (OCT) system including the swept light source apparatus according to any of the embodiments of the present invention.

In the OCT system, a beam reflected from a sample having a plurality of interfaces that are present in the optical-axis direction is taken in by one arm (a measuring unit), and a beam reflected from a reference surface is taken in by another arm (a reference unit). The two beams are caused to interfere with each other while the wavelength of the light source apparatus is swept, whereby a modulated interference signal is obtained. The modulated interference signal is then Fourier-converted. Thus, information on a cross section of the sample is obtained.

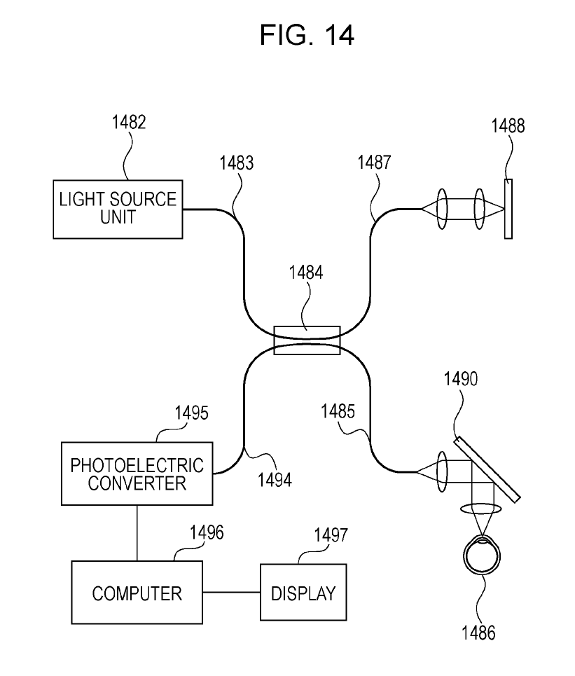

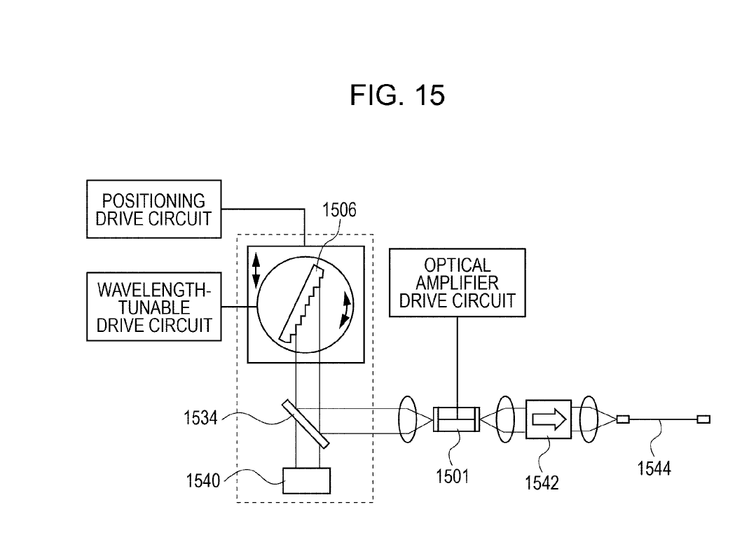

FIG. 14 schematically shows an OCT system according to the tenth embodiment of the present invention.

The system shown in FIG. 14 includes a light source unit 1482 to which the swept light source apparatus according to any of the above embodiments of the present invention is applied. A sample 1486 is the retina at the fundus of an eye. The sample 1486 is scanned with a mirror 1490. The beam reflected from the sample 1486 is transmitted through an optical fiber 1485. The mirror 1490 and the optical fiber 1485 in combination form a sample-measuring unit.

The beam reflected from a reference mirror 1488 is transmitted through an optical fiber 1487. The reference mirror 1488 and the optical fiber 1487 in combination form a reference unit.

A fiber coupler 1484 functions as an interference unit that combines the beam reflected from the sample-measuring unit and the beam reflected from the reference unit. A photoelectric converter 1495 functions as a photodetector that detects the interfering beam (modulated interference signal) from the interference unit.

A computer 1496 functions as an image processing unit that digitizes an electrically detected signal, performs data processing such as Fourier conversion, and renders a cross-sectional image of the sample 1486. That is, a cross-sectional image is obtained from the beam detected by the photodetector. The cross-sectional image is visualized on a display 1497.

A beam emitted from the light source unit 1482 travels through a fiber 1483 and is separated into two beams traveling in different directions by the fiber coupler 1484.

One of the two beams travels through the fiber 1485 and is applied to the sample 1486, i.e., the retina of an eye. The beam reflected by the sample 1486 returns through the fiber 1485 to the fiber coupler 1484.

The other of the two beams travels through the fiber 1487 and is applied to the reference mirror 1488. The beam reflected by the reference mirror 1488 returns through the fiber 1487 to the fiber coupler 1484.

The beam reflected by the surface of the sample 1486 and the beam reflected by the surface of the reference mirror 1488 are caused to interfere with each other by the fiber coupler 1484. The interfering beam is guided into a fiber 1494 and enters the photoelectric converter 1495.

In this process, when the wavelength of the beam emitted from the light source unit 1482 is changed from λ₁ to λ₂ given in Equation (12), a modulated interference signal representing a cross-sectional structure is obtained, as described above.

The modulated interference signal is digitized and is Fourier-converted by the computer 1496, whereby a cross-section signal is obtained. Since this cross-section signal only represents information at a point, the cross-section signal is measured one dimensionally by performing scanning with the mirror 1490. The result of the measurement is visualized on the display 1497 as a tomogram.

Now, supposing that the light source unit 1482 is the light source apparatus according to the first embodiment, the number of pixels and pixel pitch of the spatial modulator will be described.

As described above, the resolution and length in the depth direction of the sample detectable with the OCT system depend on the swept wavelength range of the light source spectrum and the spectral width, respectively. The detectable length in the depth direction is denoted by L in Equation (11), and the detectable resolution is denoted by ΔL in Equation (12).

The relationship between the sampling wavelength interval Δλ at which the wavelength is swept and the maximum length L in the depth direction of the sample (in the optical-axis direction) detectable with the OCT system has been expressed in Equation (11) above.

In the light source apparatus according to the first embodiment, the width Δ between the short wavelength end and the long wavelength end is 4.6 mm, and λ1-λ2 is 0.12 μm.

When the width Δ of 4.6 mm is divided by 1000 on the spatial modulator included in the light source apparatus, Δλ comes to 0.12 nm. According to Equation (11), the detectable maximum length L in the depth direction of the sample (in the optical-axis direction) comes to 11 mm.

In this case, according to Equation (12), the detectable resolution ΔL in the depth direction of the sample (in the optical-axis direction) comes to 5.5 μm.

With a light source apparatus employing a spatial modulator including 1000 pixels arranged at a pixel pitch of 4.6 μm, an OCT system realizing a detectable depth of 11 mm with a resolution of 5.5 μm is provided.

With the light source apparatus according to any of the above embodiments of the present invention, an OCT system capable of high-speed detection of a tomogram at a sweeping speed of 100 kHz or higher and realizing a large detectable depth and a high depth-direction resolution is provided.

The scope of the OCT system according to the present invention includes not only those employing, as the light source units, light source apparatuses according to the above embodiments but also those employing, as the light source units, the light source apparatus according to the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-029279, filed Feb. 12, 2010, which is hereby incorporated by reference herein in its entirety.

### REFERENCE SIGNS LIST

102 optical amplification medium
106, 166, 1006, 1206 first device
107, 167, 1007, 1207 second device
108, 1028 selecting device

1. A swept light source apparatus in which oscillation wavelength is continuously changeable, the apparatus comprising, inside a resonator:
an optical amplification medium that amplifies light;
a first device configured to disperse light emitted from the optical amplification medium and thus produce beams having different wavelengths;
a second device functioning as a non-focusing optical element and configured to collimate the beams having different wavelengths resulting from the dispersion by the first device; and
a selecting device configured to select a beam having a specific wavelength from among the beams collimated by the second device,
wherein the beam having the specific wavelength selected by the selecting device is fed back to the optical amplification medium.

2. The swept light source apparatus according to claim 1, wherein the first and second devices are of the same kind.

3. The swept light source apparatus according to claim 2, wherein the first and second devices include first and second diffraction gratings, respectively.

4. The swept light source apparatus according to claim 3, wherein the diffraction gratings have the same period.

5. The swept light source apparatus according to claim 3, wherein the diffraction gratings are provided parallel to each other.

6. The swept light source apparatus according to claim 3, wherein the diffraction gratings are provided such that the light from the optical amplification medium is perpendicularly incident on a diffraction surface of the first diffraction grating.

7. The swept light source apparatus according to claim 3, wherein the diffraction gratings are of transmissive type.

8. The swept light source apparatus according to claim 3, wherein the diffraction gratings are of reflective type.

9. The swept light source apparatus according to claim 2, wherein the first and second devices include acousto-optic devices, respectively.

10. The swept light source apparatus according to claim 1, wherein the selecting device is a spatial modulator.

11. The swept light source apparatus according to claim 10, wherein the spatial modulator includes a rotatable slit.

12. The swept light source apparatus according to claim 10, wherein the spatial modulator is a light valve.

13. The swept light source apparatus according to claim 12, wherein the light valve includes metal-foil ribbons with which light is reflected.

14. The swept light source apparatus according to claim 12, wherein the light valve includes movable micromirrors.

15. The swept light source apparatus according to claim 12, wherein the light valve includes either of an acousto-optic device and a surface-acoustic-wave device.

16. The swept light source apparatus according to claim 1, wherein the selecting device includes a light-blocking member having an aperture through which light is transmitted.

17. An optical-coherence-tomography system comprising:
a light source unit including the swept light source apparatus according to claim 1;
a sample-measuring unit configured to apply light from the light source unit to a sample and to transmit reflected light from the sample;
a reference unit configured to apply the light from the light source unit to a reference mirror and to transmit reflected light from the reference mirror;
an interference unit configured to cause the reflected light transmitted from the sample-measuring unit and the reflected light transmitted from the reference unit to interfere with each other;
a photodetector configured to detect interfering light from the interference unit; and
an image processing unit configured to obtain a cross-sectional image of the sample on the basis of the interfering light detected by the photodetector.
